(19) United States
(12) Patent Application Publication
(10) Pub. No.: US 2015/0001887 A1
(43) Pub. Date: Jan. 1, 2015

(54) ROCKER END PLATE, ASSEMBLIES INCLUDING THE SAME AND METHODS OF MAKING AND USING THE SAME

(71) Applicant: GM Global Technology Operations LLC, Detroit, MI (US)

(72) Inventors: Robert N. Saje, Shelby Township, MI (US); John C. Johnson, Macomb Township, MI (US); Terry A. Swartzell, Ann Arbor, MI (US)

(73) Assignee: GM Global Technology Operations LLC, Detroit, MI (US)

(21) Appl. No.: 14/287,610

(22) Filed: May 27, 2014

Related U.S. Application Data
(60) Provisional application No. 61/841,053, filed on Jun. 28, 2013.

(51) Int. Cl. B62D 27/02; B62D 65/00

(52) U.S. Cl. CPC B62D 27/023; B62D 65/00
USPC 296/193.08; 29/897.2

(57) ABSTRACT

A number of variations may include a product including a rocker end plate attached to at least one of a rocker, a rear rail or an outer stamping for a vehicle rear rail.

### CROSS-REFERENCE TO RELATED APPLICATIONS

This application claims the benefit of U.S. Provisional Application No. 61/841,053 filed Jun. 28, 2013.

### TECHNICAL FIELD

The field to which the disclosure generally relates to includes vehicle rocker assemblies.

### BACKGROUND

Vehicles may be equipped with rockers.

### SUMMARY OF ILLUSTRATIVE VARIATIONS

A number of variations may include a product including a rocker end plate attached to at least one of a rocker, a rear rail or an outer stamping for a vehicle rear rail.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a perspective view illustrating a product including a vehicle rocker attached to a rocker end plate, which is attached to a rear rail according to a number of variations.

FIG. 2 is a partial, perspective, enlarged view of a vehicle rocker having an open end according to a number of variations.

FIG. 3 is a partial, perspective, enlarged view of a vehicle rocker and a rocker end plate welded to the rocker according to a number of variations.

FIG. 4 is a partial, perspective, enlarged view looking rearward of a product including a vehicle rocker attached to a rocker end plate, which is attached to a rear rail according to a number of variations.

FIG. 5 is a partial, perspective, enlarged view looking forward of a product including a vehicle rocker attached to a rocker end plate, which is attached to a rear rail according to a number of variations.

FIG. 6 is a partial, sectional view of a product including a rocker, a weld, an end plate, an adhesive layer and rear rail joined together according to a number of variations.

FIG. 7 is a perspective view of a vehicle rear rail according to a number of variations.

FIG. 8 is an enlarged a perspective view of a vehicle rear rail according to a number of variations.

FIG. 9 is a perspective view of a product including a rocker, end plate and rear rail joined together according to a number of variations.

### DETAILED DESCRIPTION OF ILLUSTRATIVE VARIATIONS

The following description of the variations is merely illustrative in nature and is in no way intended to limit the scope of the invention, its application, or uses.

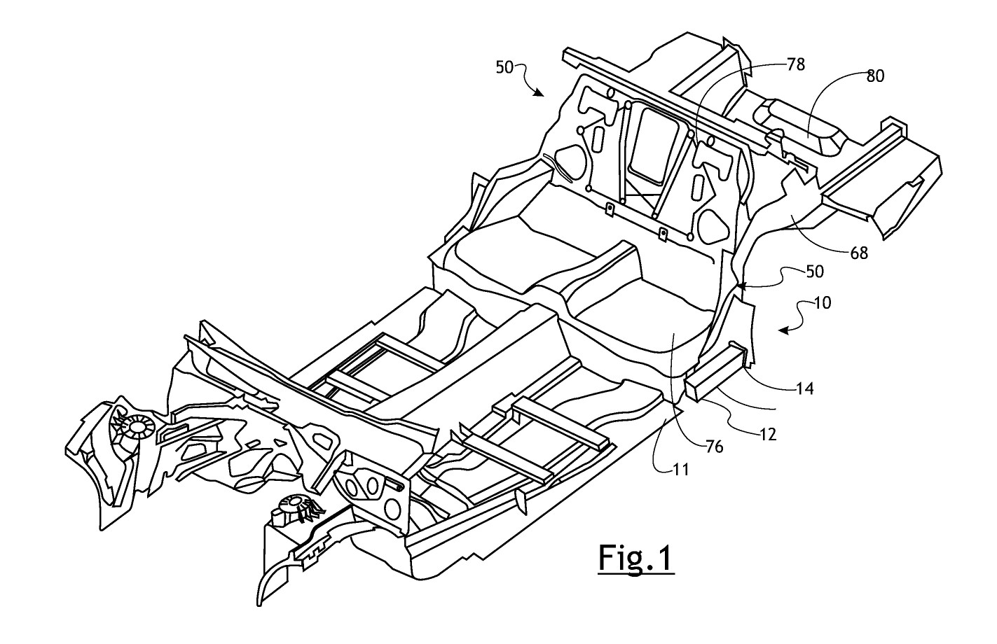

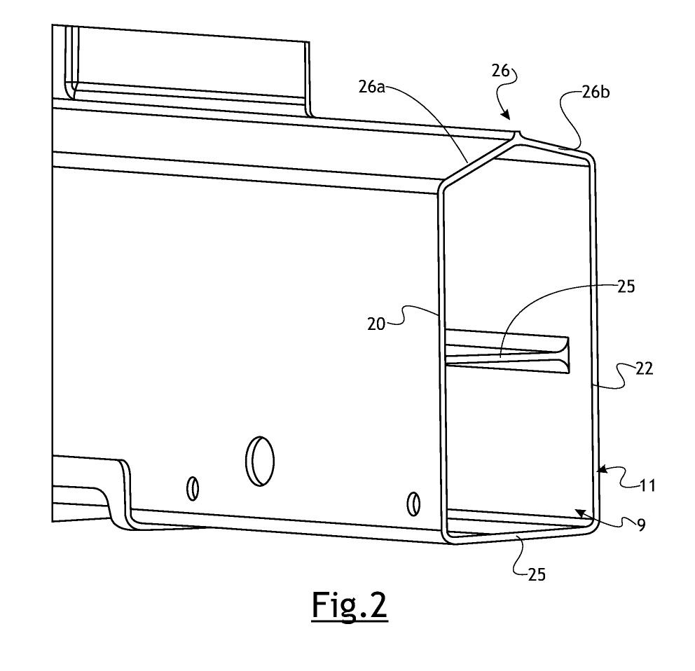

Referring now to FIGS. 1-4 and 9, a number of variations may include a product 10, which may include a rocker 12. In a number of variations the rocker 12 may be an extrusion. The rocker 12 may have an open end 9, for example as illustrated in FIG. 2. In a number of variations the rocker 12 may have an end face 11 to which the end plate 14 may be attached. The rocker may include a first side wall 10 and opposite second side wall, a bottom wall 24 and opposite top wall 26 which may include a first segment 26a and a second segment 26b, which may be joined together at an obtuse angle. The rocker 12 may include an internal support beam or wall 25, which may extend from the first side wall 20 to the opposite second side wall 22.

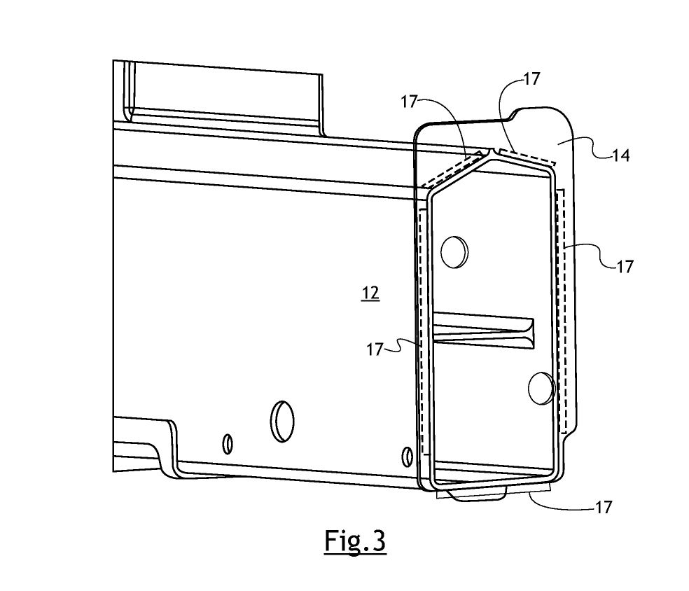

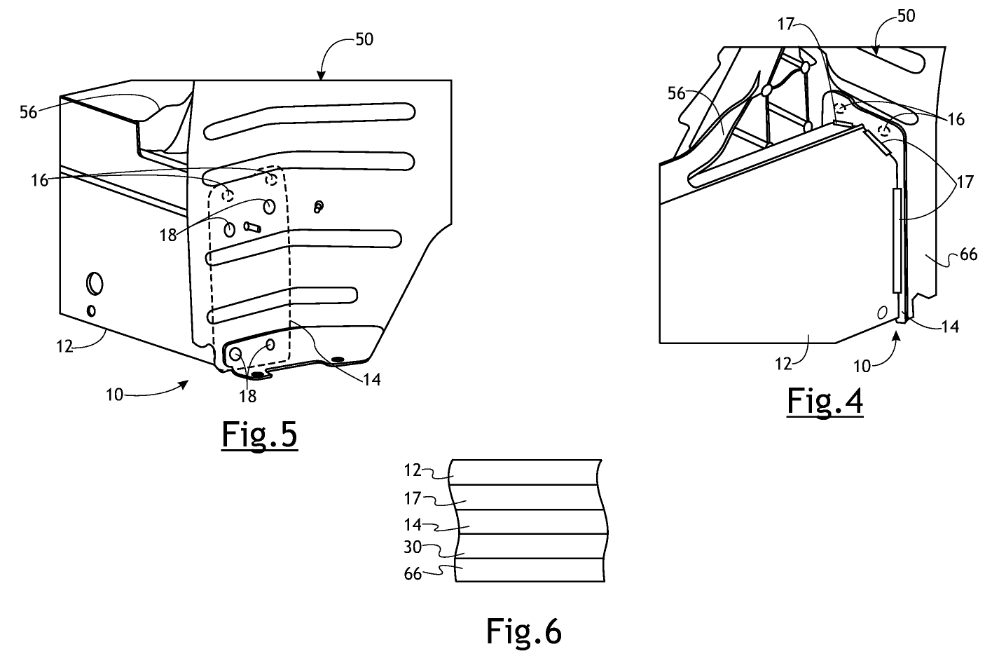

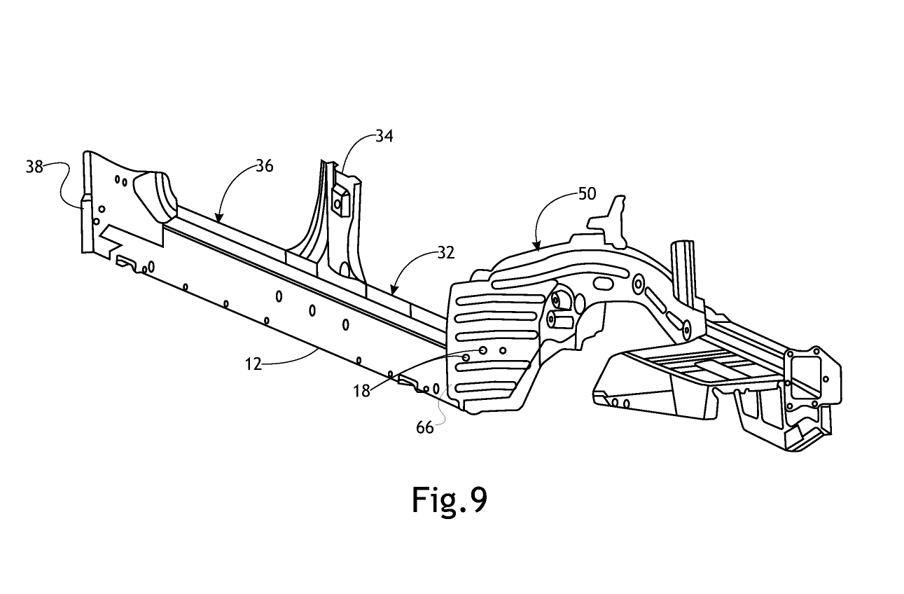

An end plate 14 may be attached to the rocker 12, for example as illustrated in FIG. 3-5. In a number of variations, the end plate 14 may be attached to the open end of the rocker 12, for example by weld spot or weld lines 17 which may be made or provide along the edge of the end face 11 at the intersection of the end plate 14 and at least one of the first side wall 10, the opposite second side wall, the bottom wall 24 or the opposite top wall 26. In a number of variations a metal inert gas (mig) welding process may be used to attach the end plate 14 to the rocker 12. The end plate 14 may also be attached to a portion of an end rail 50. The rocker 12 may be attached to a vehicle underbody 11, for example as illustrated in FIG. 1. In a number of variations, the rocker 12 may extend from the rear rail 50, under a rear door wheel 32, B-pillar 34, front door well 36 to the front hinge pillar 38, for example as illustrated in FIG. 9. The end plate 14 may be attached to an end face 13 of the rocker 12 and may overlap the end face 13, for example as illustrated in FIG. 3-4.

The end plate 14 may be attached to the rocker 12 by welding (e.g., mig weld) and/or the end plate 14 may be attached to the rocker 12 by adhesive and/or mechanical fasteners, such as but not limited to, flow drill screws 16, for example as illustrated in FIG. 5. The flow drill screws 16 may extend through a middle section 66 of a rear rail 50 and may also attach the end plate 14 to the rear rail 50. In a number of variations, as an alternative to mechanical fasteners 16 or in addition to the mechanical fasteners 16, spot welds 18 may be used to attach the end plate 14 to the rear rail 50. The spot welds 18 perform the dual function of attaching the end plate to the rear rail 50 and providing improved conductivity for electrical grounding.

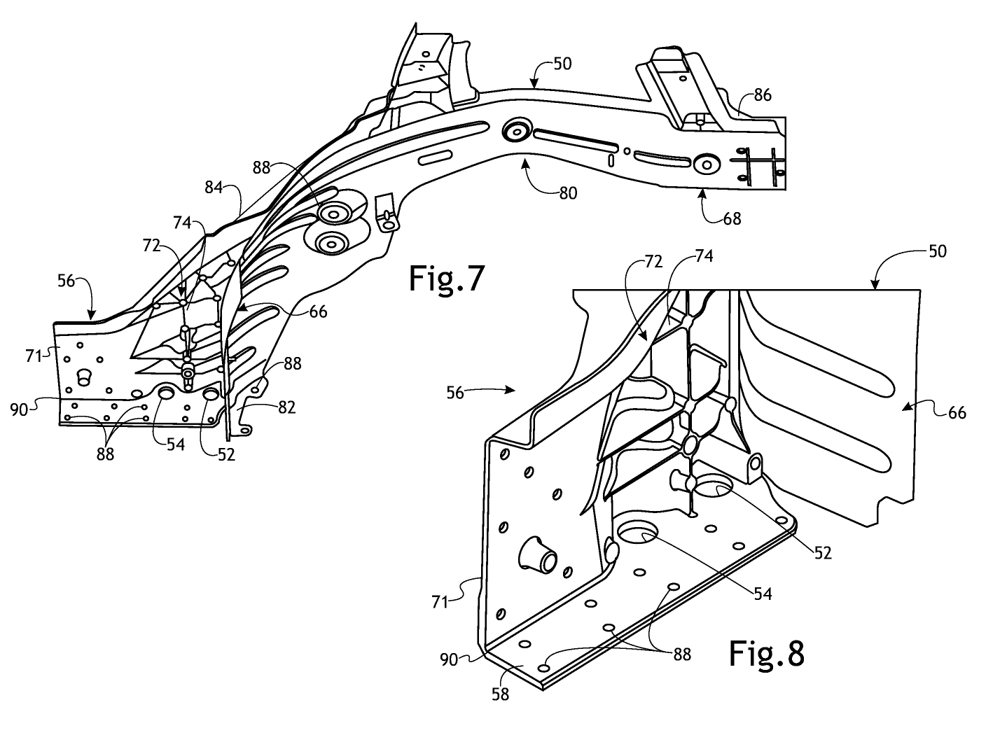

Referring to FIGS. 1 and 7-8, in any of a number of variations, the rear rail(s) 50 may be constructed and arranged to accommodate the rear wheelhouses (not illustrated) of a vehicle. The rear rail(s) 50 may include a frontal portion 56, a middle portion 66, and a rear portion 68. In a number of variations, the rear rail 50 may be a single piece. In a number of other variations, the rear rail 50 may include an outer stamping which forms the middle portion 66, and if desired a portion of the rear portion 86. The frontal portion 56, and if desired a portion of the rear potion 56, may be a stamping or an extrusion. The frontal portion 56 may include a planar base structure 58 which may lay horizontal. A side wall structure 71 may extend substantially perpendicular from the inward edge 90 of the planar base structure 58. The rearward portion 72 of the side wall structure 71 may curve inward toward the rear tire hub 80 and may also include several reinforcement structures 74. The frontal portion 56 may be constructed and arranged to accommodate at least one of the seat pan 76, a portion of a seat back panel 78, or a rear wheelhouse structure (not illustrated). The side wall 71 may be attached to the middle portion 66 of the rear rail 50. The side wall 71 may be constructed and arranged to accommodate at least one of a rear wheelhouse structure, a seat back panel 78, or a rear tire hub 80. The middle portion 66 may include a planar base structure 82. A middle wall structure 84 may extend from the base portion 82 which may be adjacent to the frontal planar base portion 58 and may curve inward toward the rear tire hub 80. The middle portion 66 may also slope upwards as it extends toward the rear portion 68. The rearward portion 68 may be constructed and arranged to accommodate at least one of a portion of the rear tire hub 80 or the rear wheelhouse. The rear portion 68 may include a structure 86 which may curve away from the rear tire hub 80. The rear rails 50 may also include several assembly features or holes 88 which may be used in the assembly of the vehicle body. The planar base portion 58 of the rear rail 50 may also include a front datum feature hole 54 which may be located at a distance forward of a rear datum feature hole 52. The datum feature holes 52, 54 may be any of a number of dimensions in order to mate with a common geo-pallet pin (not illustrated). The rear rails 50 may be constructed in any of a number of variations including, but not limited to, high pressure die casting.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: a rocker end plate attached to at least one of a rocker, a rear rail or an outer stamping for a rear rail.

Variation 2 may include a product as set forth in Variation 1 wherein the rocker end plate is attached to the rear rail and the rocker.

Variation 3 may include a product as set forth in Variation 1 wherein the rocker end plate is attached to the rear rail.

Variation 4 may include a product as set forth in Variation 1 wherein the rocker end plate is attached to the rocker.

Variation 5 may include a product as set forth in any of Variations 1-4 wherein the rocker includes a rocker end face and wherein the rocker end plate overlaps the rocker end face.

Variation 6 may include a product as set forth in any of Variations 1-5 wherein the rocker includes a first side wall and opposite second side wall, a bottom wall and a top wall, wherein the walls terminate in an end face and wherein the rocker end plate attached to the end face and overlaps each of the first side wall, opposite second side wall, a bottom wall and a top wall.

Variation 7 may include a product as set forth in any of Variations 1-6 wherein the rocker terminates in an end face and wherein the rocker plate is attached to the end face by at least one of an adhesive, a mechanical fastener or a weld.

Variation 8 may include a product as set forth in any of Variations 1-7 wherein the rocker plate is attached to the end face by an adhesive and a mechanical fastener.

Variation 9 may include a product as set forth in Variation 1-7 wherein the rocker plate is attached to the end face by a mechanical fastener.

Variation 10 may include a product as set forth in Variation 10 wherein the mechanical fastener is a flow drill screw.

Variation 11 may include a product as set forth in any of Variations 1-10 wherein the rocker end plate is attached to a rear rail by at least one of a weld or mechanical fastener.

Variation 12 may include a product as set forth in any of Variations 1-11 wherein the rocker end plate is attached to an outer stamping for a rear rail by at least one of a weld or mechanical fastener.

Variation 13 may include a product as set forth in Variation 1-11 wherein the rocker end plate is attached to an outer stamping for rear rail by a mechanical fastener.

Variation 14 may include a product as set forth in any of Variations 1-13 wherein the rocker terminates in an end face, and wherein a mechanical fastener extends through the outer stamping for a rear rail, the rocker end plate and into the rocker end face to attach the rocker, end plate and outer stamping for a rear rail together.

Variation 15 may include a product as set forth in Variation 14 further comprising at least one weld bonding the end plate and the outer stamping for a rear rail together and providing connectivity for electrical grounding.

Variation 16 may include a product as set forth in Variation 15 further comprising an adhesive layer interposed between the rocker end face and the end plate.

Variation 17 may include a product as set forth in any of Variations 1-16 wherein the rocker end plate is attached to the at least one of a rocker, a rear rail or an outer stamping for a rear rail by a weld.

Variation 18 may include a method comprising: welding an rocker end plate to a rear rail or an outer stamping for a rear rail; inserting a mechanical fastener through the rear rail or the outer stamping for a rear rail, end plate and into an end face of a rocker to attach the rear rail or the outer stamping for a rear rail, end pate and rocker together.

Variation 19 may include a product as set forth in Variation 18 comprising welding a rocker end plate to an outer stamping for a rear rail.

Variation 20 may include a method comprising: inserting a mechanical fastener through an outer stamping for a rear rail, end plate and into an end face of a rocker to attach the outer stamping for a rear rail, end pate and rocker together.

The above description of select variations within the scope of the invention is merely illustrative in nature and, thus, variations or variants thereof are not to be regarded as a departure from the spirit and scope of the invention.

What is claimed is:

1. A product comprising:
a rocker end plate attached to at least one of a rocker, a rear rail or an outer stamping for a rear rail.

2. A product as set forth in claim 1 wherein the rocker end plate is attached to the rear rail and the rocker.

3. A product as set forth in claim 1 wherein the rocker end plate is attached to the rear rail.

4. A product as set forth in claim 1 wherein the rocker end plate is attached to the rocker.

5. A product as set forth in claim 4 wherein the rocker includes a rocker end face and wherein the rocker end plate overlaps the rocker end face.

6. A product as set forth in claim 4 the rocker includes a first side wall and opposite second side wall, a bottom wall and a top wall, wherein the walls terminate in an end face and wherein the rocker end plate attached to the end face and overlaps each of the first side wall, opposite second side wall, a bottom wall and a top wall.

7. A product as set forth in claim 1 wherein the rocker terminates in an end face and wherein the rocker plate is attached to the end face by at least one of an adhesive, a mechanical fastener or a weld.

8. A product as set forth in claim 7 wherein the rocker plate is attached to the end face by an adhesive and a mechanical fastener.

9. A product as set forth in claim 7 wherein the rocker plate is attached to the end face by a mechanical fastener.

10. A product as set forth in claim 9 wherein the mechanical fastener is a flow drill screw.

11. A product as set forth in claim 1 wherein the rocker end plate is attached to a rear rail by at least one of a weld or mechanical fastener.

12. A product as set forth in claim 1 wherein the rocker end plate is attached to an outer stamping for a rear rail by at least one of a weld or mechanical fastener.

13. A product as set forth in claim 1 wherein the rocker end plate is attached to an outer stamping for rear rail by a mechanical fastener.

14. A product as set forth in claim 1 wherein the rocker terminates in an end face, and wherein a mechanical fastener extends through the outer stamping for a rear rail, the rocker end plate and into the rocker end face to attach the rocker, end plate and outer stamping for a rear rail together.

15. A product as set forth in claim 14 further comprising at least one weld bonding the end plate and the outer stamping for a rear rail together and providing connectivity for electrical grounding.

16. A product as set forth in claim 15 further comprising an adhesive layer interposed between the rocker end face and the end plate.

17. A product as set forth in claim 1 wherein the rocker end plate is attached to the at least one of a rocker, a rear rail or an outer stamping for a rear rail by a weld.

18. A method comprising:
welding an rocker end plate to a rear rail or an outer stamping for a rear rail;
inserting a mechanical fastener through the rear rail or the outer stamping for a rear rail, end plate and into an end face of a rocker to attach the rear rail or the outer stamping for a rear rail, end pate and rocker together.

19. A method as set forth in claim 19 comprising welding a rocker end plate to an outer stamping for a rear rail.

20. A method comprising:
inserting a mechanical fastener through an outer stamping for a rear rail, end plate and into an end face of a rocker to attach the outer stamping for a rear rail, end pate and rocker together.
